(19) United States
(12) Patent Application Publication
(10) Pub. No.: US 2008/0133677 A1
(43) Pub. Date: Jun. 5, 2008

(54) Automatic propagation of user profile modifications

(75) Inventors: Balaji Pattabhiraman, Chennai (IN); Kalyanaraman B. Krishnan, Velcore (IN)

Correspondence Address: SAP/BLAKELY, 1279 OAKMEAD PARKWAY, SUNNYVALE, CA, 94085-4040, US

(73) Assignee: SAP AG

(21) Appl. No.: 11/607,198

(22) Filed: Dec. 1, 2006

(51) Int. Cl. G06F 15/16

(52) U.S. Cl. 709/206; 709/204

(57) ABSTRACT

A source client generates an update event for a user profile. In response to the generated update event, contact information for one or more contacts is retrieved from a user contact list. The source client distributes the update event to one or more target clients independently of a central profile server and in accordance with the retrieved contact information.

### FIELD

Embodiments of the technology described herein relate to managing user profiles and contact information (e.g. name, address, phone number, etc) on a client computer and more particularly to enabling automatic propagation of user profile modifications to contacts in an address book or buddy list.

### BACKGROUND

Computer users commonly maintain a user profile containing the user's personal information (e.g., address, phone number, email address, fax number, etc.). This collection of personal information may be referred to herein as a user profile, a contact, or contact information. A user profile is typically managed by a computer program or application (e.g., groupware application, email program, Instant Messaging (IM) application, etc.) on the user's computer system. For example, one user might maintain a profile using an application such as Microsoft Outlook®, Lotus Notes®, or the like. Another user might maintain a profile using, for example, a Hotmail®, Yahoo®, or other web-based email accounts. These web-based applications/programs also allow a user to maintain an address book or list of contacts to manage/organize the personal information of friends, family, business contacts, etc.

When a user makes changes to his/her profile (e.g., moves to a new address, changes jobs, etc.), the user must intimate those changes to people within his/her social and/or professional network to keep in touch and collaborate effectively. To intimate profile changes/modifications, computer users traditionally were required to manually contact each person in their contact list (e.g., sending an email, making a telephone call, etc.) to notify them of the user's profile changes. Recipients of the notification were traditionally required to manually update their own address books or contacts lists with the modified profile information. For example, if Daniel moves from New York to California, he might send an email to his friends Alice, Bob and Carol notifying them of his new address. Alice, Bob and Carol must then take that information and manually enter the new address into their respective address books or contact lists. This task can be burdensome, especially given that many people change address, telephone numbers, etc., on a frequent basis and many people have very large address books and/or contact lists to maintain.

One approach to simplifying the task is to create a central profile service, such as Plaxo® (available from Plaxo, Inc. of Mountain View, Calif.), where registered users can send updated contact information to be stored on a central profile server. The central profile server maintains links between registered users that consent to share contact information with each other. Thus, when a registered user updates his/her profile, the central profile server automatically updates the information in the address books of those registered users who are linked to the registered user who has just updated his/her profile. This approach has several drawbacks. First, automatic profile updates can only take place between registered users of the service. An unregistered user is required to register and upload his/her own contact information to the central profile server/site before receiving automatic updates for registered friends, family, etc. Second, all user profiles must be stored in a central location, which opens the door for privacy and/or security issues. Another drawback is that registered users have little or no control over whether to accept or reject profile changes from others, which is particularly problematic given the lack of ability to verify the authenticity of a profile update. Yet another problem with a central profile service is that all profiles must be stored according to a common format supported/dictated by the central profile service, which means that many users will not be able to participate in the service unless/until they migrate their address books or contact lists into a program/application supported by the central profile service.

### SUMMARY

A notification agent on a user's system triggers a notification of a user profile update event when a user profile is modified by the user. In response, the notification agent retrieves contact information for one or more contacts in the user's address book or contact list. The notification agent then distributes the notification including the updated profile directly to the one or more contacts in the user's address book or contact list. Thus, a user's profile updates may be propagated automatically and directly to the user's contacts without registration with a central profile service or routing the profile update information through a central profile server. A notification unit on a target system to which a user profile update event is distributed receives a notification with the contact information from the source client. An acceptance agent on the target system causes the notification unit to accept the received notification and the contact information. A contacts updater in the target system incorporates the contact information into a contact list local to the target client.

### BRIEF DESCRIPTION OF THE DRAWINGS

The following description includes discussion of various figures having illustrations given by way of example of implementations of embodiments of the technology. The drawings should be understood by way of example, and not by way of limitation.

FIG. 1 is a block diagram illustrating an embodiment of a system that propagates user profile modifications.

FIG. 2 is a flow diagram illustrating a method for distributing user profile modifications.

FIG. 3 is a flow diagram illustrating a method for receiving user profile modifications.

### DETAILED DESCRIPTION

In one embodiment, when an individual user changes or modifies his/her user profile, a notification is sent automatically to the individual user's contacts. These contacts may be stored in the user's local address book, Instant Messaging (IM) local contact list, etc. Recipients of the notification (or target users as used herein) are given an option to update the sender's contact information in their own local contact list. In another embodiment, contact information is automatically updated into a target user's local contact list upon receipt of a notification.

In very general terms, a “user,” as used herein, refers to an individual using a computer or computer-related device. Frequently, a user will create/maintain a profile that includes personal information (e.g., name, address, phone number, etc.) As used herein, a user who modifies and/or makes changes to his/her user profile is referred to as the source user. The computer system used to modify the source user's profile is referred to herein as the source system or source client. The computer system that receives a notification (on behalf of a target user) of the source user's updated profile is referred to as the target system or target client. The source and target systems can be any system having a processor capable of processing direct user input/output (I/O) interactions. These systems include, but are not limited to, desktop computers, notebook computers, personal digital assistants (PDAs), cell phones, etc.

Both source and target systems include software programs/applications for storing and/or maintaining contacts and contact information. For example, email software (e.g., Mozilla Thunderbird, Microsoft Outlook Express, etc.) typically includes an address book feature that allows a user to maintain/store contact information for various friends, family, business associates, co-workers, etc. Additionally, many computer users engage in instant messaging (IM). Similar to email software, IM applications provide functionality for a user to maintain a list of contacts. Other software applications that support address books and/or contacts lists, include, but are not limited to, Microsoft Outlook, available from Microsoft Corporation of Redmond, Wash., and Customer Relationship Management (CRM), available from SAP AG of Walldorf, Germany.

A source user modifies his/her profile (e.g., changes his/her email address). This modification of a user profile is referred to as a profile update event. When a profile update event is received/detected at the source system, a list of contacts is automatically retrieved from a local address book or contact list. A notification object is created within the source system/client that includes the profile update event and is automatically sent to the list of contacts. The notification object contains the full profile information of the source user in an electronic business card (e.g., a vCard, which is described in detail in Request for Comments (RFC) 2425 entitled, “A MIME Content-Type for Directory Information,” by T. Howes et al., September 1998, and RFC 2426 entitled, “vCard MIME Directory Profile,” by F. Dawson et al., September 1998.) The electronic business card is sent to various contacts in the body of an email.

The notification of the profile update event may be in the format of a plain text email (described in RFC 2822 entitled, “Internet Message Format,” by P. Resnick, April 2001) having an optional extended property in the message header. An extended property, referred to as an x-prop, is a mechanism provided to add custom extensions to the structure of an email. An x-prop can be included in the message header of an email to identify the email as a notification of a profile modification (e.g., profile update event) and to distinguish the notification from normal/standard emails created from standard email clients. An x-prop may also serve to mitigate the risk that normal/standard emails sent from a standard email client will have the same custom properties as a notification email that includes an x-prop.

In one embodiment, the notification email is digitally signed and/or encrypted to allow the recipient (e.g., target user) to verify the authenticity of the sender. In this way, false updates, spam, or other spurious emails can be easily identified and/or discarded.

When a target system receives a notification that includes a vCard, a notification unit extracts the vCard from the body of the email. In an alternate embodiment, rather than a vCard, the received notification includes profile information data in another format. If an auto-accept agent is enabled, the vCard is passed to a contacts updater. As used herein, an auto-accept agent refers to an agent that triggers the notification unit to automatically pass profile update events to the contacts updater. If the auto-accept agent is disabled or if there is no auto-accept agent, the notification unit will generate a request for the target user to accept or reject the notification. If the target user accepts the notification, the notification unit then passes the vCard and/or vCard information to the contacts updater. Additionally, if the notification includes a digital signature, the notification unit may use the digital signature to verify the authenticity of the sender.

In one embodiment, the contacts updater parses the vCard and creates a system specific contact object. The contact object is checked against a list of contacts already stored in a local address book or contact list on the target system. An email address field or other field identifier may be used as the unique identifier to compare the contact object against the contacts already stored in the system.

In one embodiment, the vCard may contain an x-prop to denote the previous email address of the source user in the case where the email address has been changed in the source user's profile. If the target user's address book or contact list includes an existing contact profile for the source user, the target system can use the previous email address denoted in the x-prop to lookup the contact profile for the source user. The existing contact profile may then be updated rather than forcing the system to create a new contact profile for the source user.

Despite the exchange of contact information between source and target users, it is not necessary that the source and target users manage/maintain/store their contacts using the same or similar application/program. Embodiments of the technology provide a fully distributed solution for automatically exchanging contact information. One source user may manage his/her profile and contact list using, for example, a Lotus Notes address book while a target user manages his/her profile and contact list using mySAP CRM. In other words, embodiments of the technology described herein allow profile update events to be distributed directly to various targets irrespective of the application and/or format used to manage profile updates and contact information.

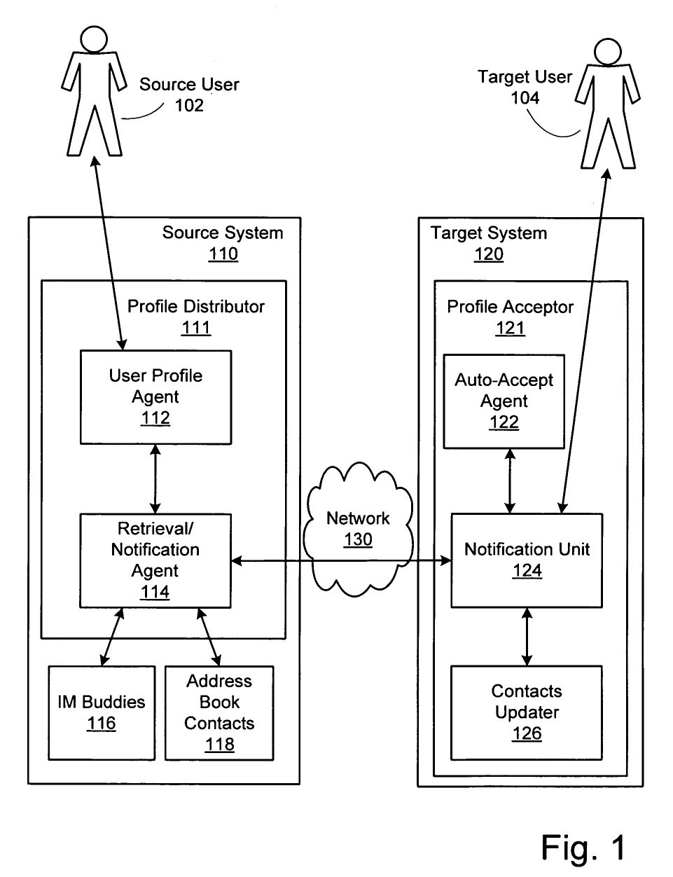

FIG. 1 illustrates an embodiment of a source system 110 and a target system 120. Systems 110 and 120 can be any computer system capable of processing user input/output (e.g., desktop computer, notebook computer, handheld processing device, PDA, cell phone, etc.). System 110 includes a profile distributor 111, which can be implemented in hardware, software, or some combination of hardware and software. When a source user 102, inputs information modifying his/her profile, a profile update event is sent from user profile agent 112 to retrieval/notification agent 114. The modified information may include a new address, phone number, email address, etc., or any combination thereof. Retrieval/notification agent 114 receives the profile update event and retrieves contact information (e.g., from the source user's local IM buddies 116 and/or address book contacts 118.) Contact information may be retrieved from any list of contact information accessible by retrieval/notification agent 114.

In one embodiment, retrieval/notification agent 114 retrieves email addresses for each contact in IM buddies 116 and/or address book 118 and automatically sends the profile update event to each of the email addresses via network 130. In other embodiments, retrieval/notification agent 114 retrieves other information for each of the contacts (e.g., names) from IM buddies 116 and/or address book contacts 118 and sends a prompt to source user 102 to select which of the contacts he/she desires to notify. The profile update event is then sent to the selected contacts via network 130. Network 130 can be any public or private network, such as a local area network (LAN), wide area network (WAN), metropolitan area network (MAN), the Internet, etc.

In one embodiment, the profile update event is sent as a vCard embedded in a plain text email. The email may alternatively include one or more x-props to further define the profile update event and/or distinguish the email from normal/standard emails sent from a standard email client. In other embodiments, contact information may be distributed by email in a format different from a vCard. Retrieval/notification agent 114 may also include a digital signature or other form of encryption to allow the recipient of the notification to verify the authenticity of the profile update event.

FIG. 1 shows the profile update event being received by target system 120. For convenience and clarity, only one target system is shown in the embodiment of FIG. 1. However, many target clients corresponding to respective contacts in the source user's contact list may also receive the profile update event in other embodiments.

When a profile update is sent to target system 120, it is handled by profile acceptor 121, which may be implemented in hardware, software, or some combination of hardware and software. The profile update is received by a notification unit 124. Notification unit 124 extracts the vCard and/or contact information corresponding to the profile update event from the body of the email. Notification unit 124 may also verify the authenticity of the profile update event if the profile update event email includes a digital signature or other form of encryption. Once authenticity has been verified, an enabled auto-accept agent 122 triggers notification unit 124 to automatically pass the profile update event to a contacts updater 126. In another embodiment, auto-accept agent may be disabled or nonexistent in target system 122. In this situation, notification unit 124 sends a prompt to target user 104 requesting acceptance of the received profile update event. The prompt may include details of the profile update event and/or a notification verifying the authenticity of the profile update event. In another embodiment, the prompt may include a request for target user 104 to inspect and verify a digital signature. Once the profile update event has been accepted by the target user, notification unit 124 passes the profile update event to contacts updater 126.

In one embodiment, contacts updater 126 parses the profile update event into fields (e.g., name, address, phone number, etc.) and creates a specific contact object. The list of contacts stored in target system 120 is searched in an attempt to find a match for the newly created contact object. Specifically, contacts updater 126 uses a specific field from the contact object (e.g., the address field) to search for a matching contact. If contacts updater 126 finds a matching profile for the contact object, the profile is updated with the new contact information. If no matching profile is found, contacts updater 126 generates a new profile for the source user and stores the new contact information.

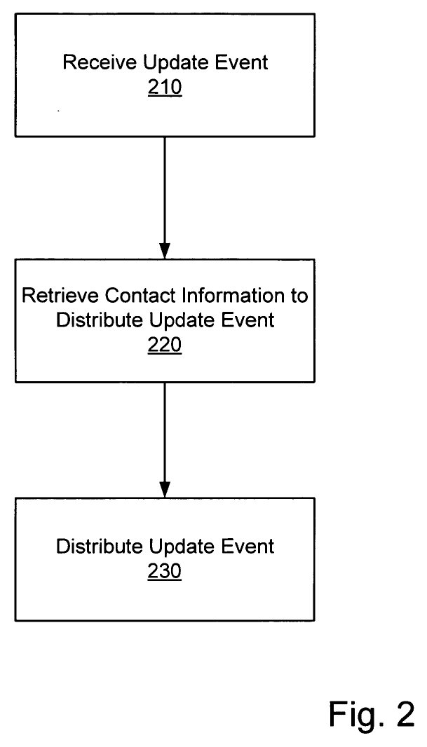

FIG. 2 is a flow diagram illustrating an embodiment of a method for distributing user profile modifications. When a user inputs new or updated information into his/her profile (e.g., name, address, phone number, etc.), a profile update event is generated by the source client. A notification agent receives the update event 210. The user may input the new/updated information into the source client using any application/program that manages contact information (e.g., email clients, IM applications, general address book and/or contact list applications, etc.). Once the update event is received 210, the notification agent retrieves contact information for distributing the update event to various contacts 220. Contact information is retrieved from a local address book or contact list on the source client.

In one embodiment, the user may select particular contacts (based on the retrieved contact information) to receive the update event. In another embodiment, the user pre-defines parameters for an update event to be sent automatically to all contacts or a sub-group of contacts in the user's address book or contact list. The update event is distributed directly to the selected or pre-defined contacts 230. As used herein, “direct” distribution refers to sending an update event from the source client to the target client without routing the update event through a centralized profile server or system (e.g., Plaxo®). In other words, an update event that travels through a standard network server or router in route to the target client is still directly distributed; however, an update event that is routed through a centralized server or system is not directly distributed.

In one embodiment, the update event is distributed in the body of a plain text email. The email may also include a digital signature or other form of encryption to allow the recipient to verify the authenticity of the update event. The recipients of the emailed update event do not need to be registered with any central profile server and do not need to manage/maintain contact information according to any particular format. The program and/or application used by recipients of the update event can be different from the program and/or application used by the sender of the update event. Thus, embodiments of the technology allow profile update events to be distributed directly (rather than having to route profile update events through a central profile server that provides a contact management service) to various targets irrespective of the application and/or format used to manage profile updates and contact information.

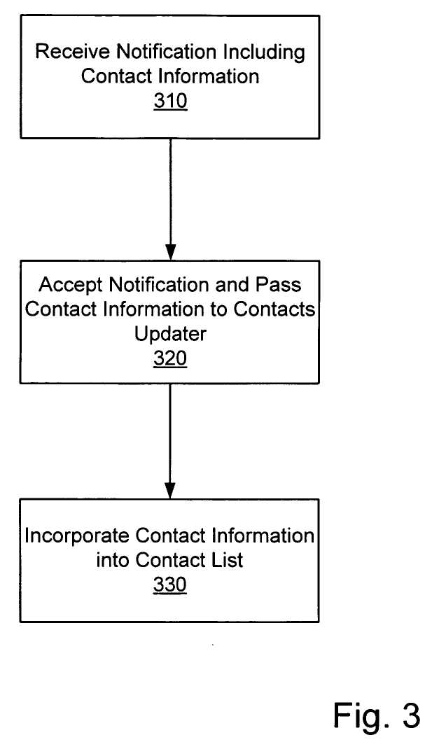

FIG. 3 is a flow diagram illustrating an embodiment of a method for receiving user profile modifications. A notification unit on a target system to which a user profile update event is distributed receives a notification with the contact information from the source client 310. An acceptance agent on the target system causes the notification unit to accept the received notification and the contact information 320. In one embodiment, the acceptance agent automatically accepts the notification and the contact information. In another embodiment, the acceptance agent accepts the notification and the contact information based on a user's explicit acceptance. For example, a pop-up window may appear on a user's computer screen when the notification unit receives a notification. The pop-up window may provide one or more boxes to allow the user to accept or reject the notification and the contact information. A contacts updater in the target system incorporates the contact information into a contact list local to the target client 330.

Embodiments of the technology described above may include hardware, software, and/or a combination of these. In a case where an embodiment includes software, the software data, instructions, and/or configuration may be provided via an article of manufacture by a machine/electronic device/hardware. An article of manufacture may include a machine accessible/readable medium having content to provide instructions, data, etc. The content may result in an electronic device, for example, a filer, a disk, or a disk controller as described herein, performing various operations or executions described. A machine accessible medium includes any mechanism that provides (e.g., stores and/or transmits) information/content in a form accessible by a machine (e.g., computing device, electronic device, electronic system/subsystem, etc.). For example, a machine accessible medium includes recordable/non-recordable media such as read only memory (ROM), random access memory (RAM), magnetic disk storage media, optical storage media, flash memory devices, etc. The machine accessible medium may further include an electronic device having code loaded on a storage that may be executed when the electronic device is in operation. Thus, delivering an electronic device with such code may be understood as providing the article of manufacture with such content described above.

As used herein, references to one or more “embodiments” are to be understood as describing a particular feature, structure, or characteristic included in at least one implementation of the technology. Thus, phrases such as “in one embodiment” or “in an alternate embodiment” appearing herein describe various embodiments and implementations of the technology, and do not necessarily all refer to the same embodiment. However, they are also not necessarily mutually exclusive.

Besides what is described herein, various modifications may be made to the disclosed embodiments and implementations of the technology without departing from their scope. Therefore, the illustrations and examples herein should be construed in an illustrative, and not a restrictive sense. The scope of the invention should be measured solely by reference to the claims that follow.

What is claimed is:

1. A method, comprising:
generating an update event for a user profile at a source client;
retrieving contact information for one or more contacts from a user contact list in response to receiving the update event; and
distributing the update event from the source client directly to one or more target clients in accordance with the retrieved contact information.

2. The method of claim 1, wherein distributing the update event comprises distributing an email that includes the update event from the source client to the one or more target clients.

3. The method of claim 2, wherein distributing the email that includes the update event comprises:
incorporating the update event into an electronic business card;
including the electronic business card as plain text in the body of an email; and
sending the email to the one or more contacts.

4. The method of claim 2, further comprising attaching a digital signature to the email to indicate an authorized modification source.

5. The method of claim 1, wherein the contact information from the user contact list is maintained according to a first format and contact information stored on at least one target client is maintained according to a second format.

6. A profile distributor for de-centralized propagation of user profile modifications, comprising:
a user profile agent to receive a profile modification of a user at a source client;
a contact retrieval agent at the source client to retrieve contact information for one or more contacts from a user contact list in response to receiving the profile modification; and
a notification agent at the source client to automatically distribute a notification including the profile modification to the one or more contacts at one or more remote target clients.

7. The profile distributor of claim 6, wherein the notification comprises an email and the profile modification is included as plain text in the body of the email.

8. The profile distributor of claim 7, wherein the email includes a digital signature to authenticate the notification.

9. The profile distributor of claim 7, wherein the profile modification is incorporated into at least one of an electronic business card or a vCard.

10. The profile distributor of claim 7, wherein the contact information is retrieved from at least one of an address book or an Instant Messaging (IM) local to the source client.

11. The profile distributor of claim 6, wherein the contact information in the user contact list is maintained according to a first format and contact information in a contact list of a contact that receives the distributed notification is maintained according to a second format.

12. An article of manufacture comprising a machine-accessible medium having content to provide instructions to result in an electronic device performing operations including:
receiving an update event for a user profile on a source client;
retrieving contact information for one or more contacts from a user contact list in response to receiving the update event; and
distributing the update event from the source client to one or more target clients in accordance with the retrieved contact information.

13. An article of manufacture according to claim 12, wherein distributing the update event comprises sending an email that includes the update event from the source client to the one or more target clients.

14. An article of manufacture according to claim 12, wherein sending an email that includes the update event comprises:
incorporating the update event into an electronic business card;
including the electronic business card as plain text in an email; and
sending the email from the source client to the one or more target clients.

15. An article of manufacture according to claim 12, the machine-accessible medium having content to provide instructions to result in an electronic device performing further operations including attaching a digital signature to the email.

16. A profile acceptor, comprising:
a notification unit to receive a notification from a source client at a target client, the notification including contact information for a user of the source client;
a contacts updater to receive the contact information and incorporate the contact information into a contact list local to the target client; and
an acceptance agent to cause the notification unit to accept the received notification and pass the contact information to the contacts updater at the target client.

17. The profile acceptor of claim 16, wherein the notification comprises a vCard incorporating the contact information.

18. The profile acceptor of claim 16, wherein the auto-accept agent verifies authenticity of a digital signature in the notification.

19. The profile acceptor of claim 16, wherein contact information in a contact list associated with the user of the source client is maintained according to a first format and contact information in the contact list associated with the user of the target client is maintained according to a second format.
